(19) United States
(12) Patent Application Publication
(10) Pub. No.: US 2018/0318712 A1
(43) Pub. Date: Nov. 8, 2018

(54) SYSTEM AND METHOD FOR MANAGING THE PRESENTATION OF CONTENT IN A MULTIPLAYER ONLINE GAME

(71) Applicant: MZ IP Holdings, LLC, Palo Alto, CA (US)

(72) Inventors: Ajk Palikuqi, San Jose, CA (US); Jai Kim, San Mateo, CA (US)

(21) Appl. No.: 15/969,269

(22) Filed: May 2, 2018

Related U.S. Application Data
(60) Provisional application No. 62/501,333, filed on May 4, 2017.

(51) Int. Cl. A63F 13/47; A63F 13/69

(52) U.S. Cl. CPC A63F 13/47; A63F 2300/638; A63F 2300/632; A63F 13/69

(57) ABSTRACT

Implementations of the present disclosure are directed to a method, a system, and an article for managing the presentation of content in a multiplayer online game. An example method can include: providing, to a plurality of users, a multiplayer online game having a virtual environment; assigning, to at least one of the users, a timeline defining times at which items of content will be introduced into the virtual environment for the at least one user; advancing the virtual environment forward in time; and introducing the items of content into the virtual environment according to the times defined by the timeline.

### CROSS-REFERENCE TO RELATED APPLICATIONS

This application claims the benefit of U.S. Provisional Patent Application No. 62/501,333, filed May 4, 2017, the entire contents of which are incorporated by reference herein.

### BACKGROUND

The present disclosure relates to multiplayer online games and, in some examples, to systems and methods for managing the presentation of content in a multiplayer online game.

In general, a multiplayer online game can be played by hundreds of thousands or even millions of players who use client devices to interact with a virtual environment for the online game. The players are typically working to accomplish tasks, acquire assets, or achieve a certain score or level in the online game. Some games require or encourage players to form groups or teams that can play against other players or groups of players.

In a typical example, a player interacts with the virtual environment by providing input to a user input device. Common user input devices for games can include, for example, a touch screen, a keypad, a joystick, and/or a keyboard. With a touch screen, users can interact with the virtual environment by tapping or selecting items displayed on the screen.

### SUMMARY

In general, the systems and methods described herein provide a consistent and automated approach for managing the presentation of content (e.g., game features, events, new rules, virtual items, etc.) in a computer game, such as a multiplayer online game. One or more timelines can be created that define times at which items of content will be introduced in the game. One of the timelines can be assigned to a group of users of the game. As the game (or virtual environment for the game) advances in time, the items of content can be introduced to the group of users, according to the timeline.

Advantageously, the approach described herein can greatly simplify and improve the ability of a game to manage the presentation of content, particularly when the game grows in size to include millions of users who can interact with one another and influence game events. The approach can allow a time abstraction to be managed for one or more users and can make it possible to programmatically automate every item of content that is introduced or delivered to the users. The approach is generally scalable and can allow the game to accommodate and manage content for new users as the game grows in popularity. Unlike previous approaches, the use of timelines can avoid manual intervention and/or can ensure that each player receives content in a similar, consistent manner. This can level the playing field and prevent any users from receiving an unfair advantage due to an inconsistent delivery of game content. Additionally or alternatively, by avoiding or not requiring manual intervention, the approach described herein can reduce a number of game operators needed to run a game, thereby lowering cost and effort required to maintain or manage the game.

In one aspect, the subject matter described in this specification relates to a computer-implemented method. The method includes: providing, to a plurality of users, a multiplayer online game having a virtual environment; assigning, to at least one of the users, a timeline defining times at which items of content will be introduced into the virtual environment for the at least one user; advancing the virtual environment forward in time; and introducing the items of content into the virtual environment according to the times defined by the timeline.

In certain examples, the multiplayer online game can include a lifecycle having a plurality of phases. The timeline can correspond to a single phase from the plurality of phases. Each phase can include at least one distinct timeline. At least one phase can include overlapping timelines. The lifecycle can include a series of timelines, and each timeline in the series can include or define a portion of the lifecycle.

In some implementations, the at least one user includes a group of new players of the online game. The timeline can include a tree structure having nodes and branches. The items of content can include at least one of a game event, a game feature, a game rule, a virtual item, a virtual character, and any combination thereof. Advancing the virtual environment forward in time can include running a game clock for the online game.

In another aspect, the subject matter described in this specification relates to a system. The system includes one or more computer processors programmed to perform operations including: providing, to a plurality of users, a multiplayer online game having a virtual environment; assigning, to at least one of the users, a timeline defining times at which items of content will be introduced into the virtual environment for the at least one user; advancing the virtual environment forward in time; and introducing the items of content into the virtual environment according to the times defined by the timeline.

In various examples, the multiplayer online game can include a lifecycle having a plurality of phases. The timeline can correspond to a single phase from the plurality of phases. Each phase can include at least one distinct timeline. At least one phase can include overlapping timelines. The lifecycle can include a series of timelines, and each timeline in the series can include or define a portion of the lifecycle.

In certain implementations, the at least one user includes a group of new players of the online game. The timeline can include a tree structure having nodes and branches. The items of content can include at least one of a game event, a game feature, a game rule, a virtual item, a virtual character, and any combination thereof. Advancing the virtual environment forward in time can include running a game clock for the online game.

In another aspect, the subject matter described in this specification relates to an article. The article includes a non-transitory computer-readable medium having instructions stored thereon that, when executed by one or more computer processors, cause the computer processors to perform operations including: providing, to a plurality of users, a multiplayer online game having a virtual environment; assigning, to at least one of the users, a timeline defining times at which items of content will be introduced into the virtual environment for the at least one user; advancing the virtual environment forward in time; and introducing the items of content into the virtual environment according to the times defined by the timeline.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for managing content presentation in a multiplayer online game.

FIG. 2 is a schematic diagram of an example timeline for a multiplayer online game.

FIG. 3 is a schematic diagram of an example lifecycle for a multiplayer online game.

FIG. 4 is a flowchart of an example method of using a timeline to manage content presentation in a multiplayer online game.

### DETAILED DESCRIPTION

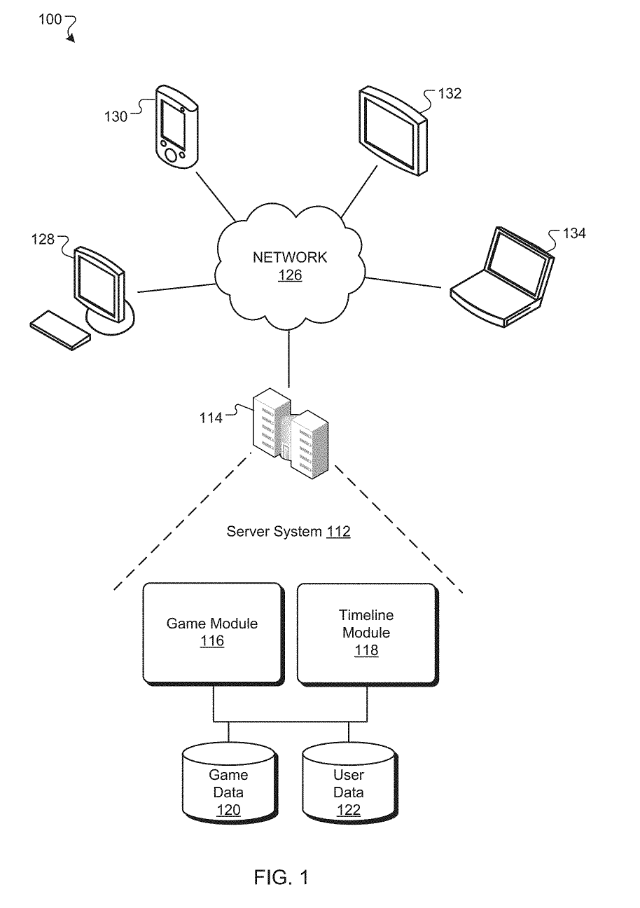

FIG. 1 illustrates an example system 100 for managing the presentation of content in a multiplayer online game. A server system 112 provides functionality for implementing timelines that define when items of content will be introduced into the online game. The server system 112 includes software components and databases that can be deployed at one or more data centers 114 in one or more geographic locations, for example. The server system 112 software components can include a game module 116 and a timeline module 118. The software components can include subcomponents that can execute on the same or on different individual data processing apparatus. The server system 112 databases can include game data 120 and user data 122 databases. The databases can reside in one or more physical storage systems. The software components and data will be further described below.

An application, such as, for example, a web-based application, can be provided as an end-user application to allow users to interact with the server system 112. The end-user application can be accessed through a network 126 (e.g., the Internet) by users of client devices, such as a personal computer 128, a smart phone 130, a tablet computer 132, and a laptop computer 134. Other client devices are possible. In alternative examples, the game data 120 and/or the user data 122 or any portions thereof can be stored on one or more client devices. Additionally or alternatively, software components for the system 100 (e.g., the game module 116 and/or the timeline module 118) or any portions thereof can reside on or be used to perform operations on one or more client devices.

FIG. 1 depicts the game module 116 and the timeline module 118 as being able to communicate with the databases (e.g., the game data 120 and the user data 122 databases). The game data 120 database generally includes information related to the multiplayer online game implemented using the system 100. The game data 120 database can include, for example, information related to a virtual environment for the game, image, video, and/or audio data for the game, event data corresponding to previous, current or future game events, game rules, game items, and/or game state data defining a current state of the game. The user data 122 database generally includes data related to user interactions with the online game and/or the virtual environment. Such information can be or include, for example, a history of user connections to the system 100, user purchases, user accomplishments, user tasks, user interactions with other users (e.g., group chats), user virtual item acquisition or usage, and/or other user conditions in the virtual environment and/or real world.

The multiplayer online game can be or include, for example, an adventure game, a virtual playing card game, a virtual board game, a vehicle operating game, or other type of multiplayer game. In preferred examples, the multiplayer online game includes a virtual environment in which users or the users' avatars can have various capabilities. The capabilities can be or include, for example, moving an avatar or a virtual item or object to a different geographical location, interacting with characters or other users, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible.

In general, the game module 116 and the timeline module 118 can include software components and/or processing components configured to provide and manage the online game for a plurality of users. The game module 116, for example, can be configured to implement the game on user client devices (e.g., the personal computer 128, the smart phone 130, the tablet computer 132, and the laptop computer 134) and manage a game state for the server system 112 and the client devices. This can involve rendering a virtual environment for the online game and/or updating the game state according to user actions and game events. The timeline module 118 can manage and/or utilize one or more timelines for the purpose of introducing items of content into the online game. The items of content can be or include, for example, a game event (e.g., a conflict or competition among players), a game feature (e.g., a new user capability), a game rule, a virtual item (e.g., a virtual weapon or playing card), a virtual character (e.g., a virtual animal or person), and any combination thereof. As the online game progresses in time, the game module 116 and/or the timeline module 118 can introduce the items of content according to the one or more timelines.

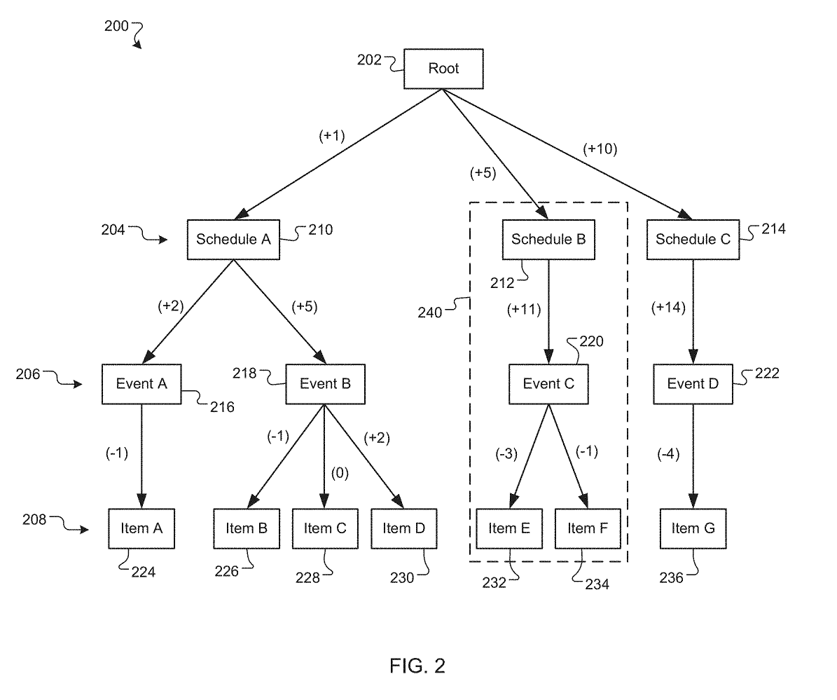

For example, FIG. 2 is a schematic diagram of an example timeline 200 that can be used (e.g., by the timeline module 112) to introduce items of content at different times into the online game. As depicted, the timeline 200 can be arranged as a tree structure that includes a collection of nodes and branches. A beginning point for the timeline 200 is represented by a root node 202. The branches (represented by line segments) can connect the root node 202 to a layer of schedule nodes 204, a layer of event nodes 206, and a layer of content nodes 208. In general, the schedule nodes 204 can represent locations in the timeline 200 where one or more game events can be initiated or scheduled. The schedule nodes 204 in this example include nodes 210, 212, and 214, representing schedules A, B, and C, respectively. Likewise, the event nodes 206 can represent locations in the timeline 200 where the scheduled game events can occur. The event nodes 206 in this example include nodes 216, 218, 220, and 222, representing events A, B, C, and D, respectively. Additionally or alternatively, the content nodes 208 (alternatively referred to as leaf nodes) can represent locations in the timeline 200 where items of content associated with the game events are introduced. The content nodes 208 in this example include nodes 224, 226, 228, 230, 232, 234, and 236, representing content items A, B, C, D, E, F, and G, respectively. While there are seven items of content represented in the timeline 200 (i.e., items A through G), it is understood that other timelines can include any suitable number of content items (e.g., hundreds, thousands, etc.). It is further understood that any suitable number of schedule nodes and any suitable number of event nodes can be included in a timeline.

In various examples, the timeline 200 can be used to determine when each of the content items (A through G) will be introduced into the online game. For example, each branch in the timeline 200 can be associated with or define an amount of time (e.g., in seconds, minutes, hours, or days) that transpires between a first node on one end of the branch and a second node on an opposite side of the branch. For purposes of illustration and not limitation, the amounts of time for the various branches in the timeline 200 are indicated in parentheses in FIG. 2. For example, the amount of time between the root node 202 and the schedule A node 210 is +1 (e.g., 1 second). Additionally or alternatively, an amount of time between any two nodes along a path from the root node 202 can be determined by adding the times for any branches between the two nodes. For example, the amount of time between the root node 202 and node 224 (for item A) is +2 (i.e., 1+2−1=2). In other words, if the timeline 200 is applied in the online game at time t=0 (e.g., the root node 202 occurs at time t=0), item A will be introduced into the online game at time t=2 (e.g., 2 seconds). Following this approach, Table 1 presents the times at which items A through G will be introduced into the online game, assuming the root node 202 is applied at time t=0. If the root node 202 is applied at a later time (e.g., t=10), the times in Table 1 can be added to the later time (e.g., item A can be introduced at t=12).

TABLE 1
Times at which items A through G in the timeline 200 can
be introduced into the online game, if the root node 202
is applied at time t = 0.

| | Time of Introduction |
|---|---|
| Item | into Online Game |
| A | 2 |
| B | 5 |
| C | 6 |
| D | 8 |
| E | 13 |
| F | 15 |
| G | 20 |

Advantageously, the tree structure used for timelines, such as the timeline 200, is generally modular, which can facilitate timeline development and modification. For example, if content items E and F will be presented in the game at multiple times, a timeline module 240, which includes the content items E and F (and schedule B and event C) can be copied and inserted into a different location in a timeline and/or into a different timeline. In general, any grouping or collection of nodes and branches (e.g., also referred to as a module) in a timeline can be reused in a different portion of the timeline or added to one or more other timelines. Additionally or alternatively, such modules can be moved from one location to a different location, as game developers modify or update the online game. In general, however, it can be preferable to avoid having more than one copy of a module (e.g., the timeline module 240) and to instead maintain and use a single, master copy, which can be accessed from multiple timelines and/or by more than one location within a single timeline. In such instances, a timeline can include a link to the master copy of the module. Any changes made to the master copy can then be automatically included each time the master copy is used.

Additionally or alternatively, the tree structure used for timelines, such as the timeline 200, can be considered to include a root node and one or more schedules. Each schedule can include one or more events, and each event can include one or more items of content. Further, a node in the structure can have a parent node that is closer to the root node and a child node that is farther from the root node. Schedule nodes (e.g., the schedule nodes 204) generally have at least one parent node (e.g., a root node) and at least one child node (e.g., an event node). Event nodes (e.g., the event nodes 206) generally have at least one parent node (e.g., a schedule node) and at least one child node (e.g., a content node). Content nodes (e.g., the content nodes 208) generally have at least one parent node (e.g., an event node) and no child nodes. In various examples, an event node and/or a content node can have more than one parent node. This allows the event node and/or the content node to be reached from more than one path in the timeline. For example, an item of content can be introduced into the game more than once when the associated content node has more than one parent event node.

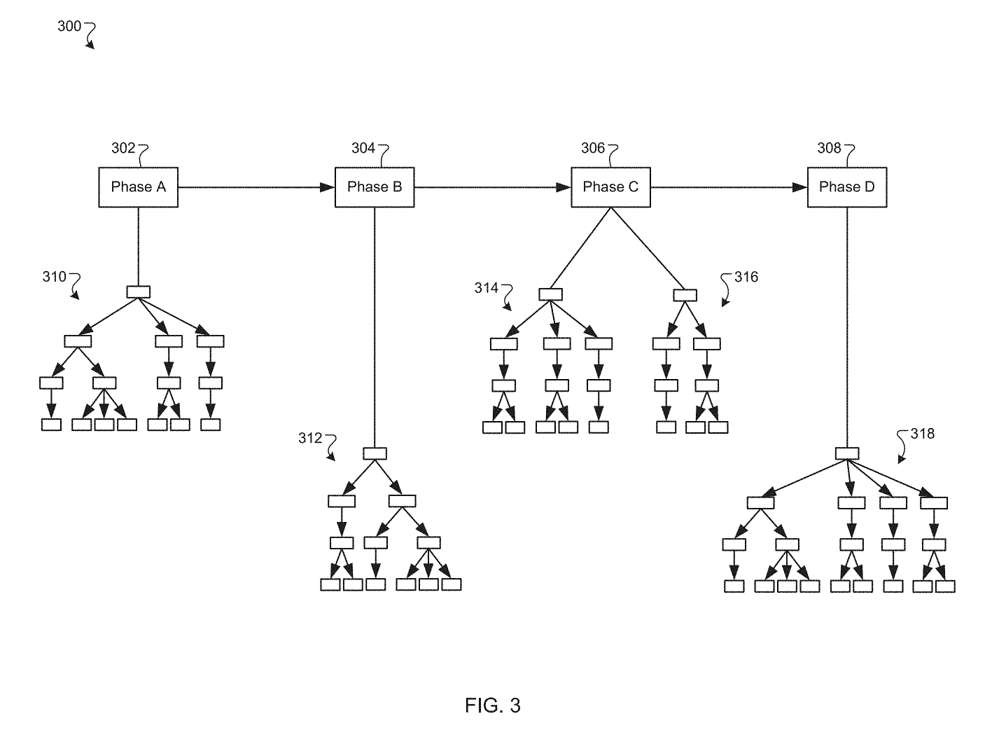

In various implementations, the online game can include multiple phases that can be managed with multiple timelines. For example, referring to FIG. 3, the online game can include a lifecycle 300 that has four phases: phase A 302, phase B 304, phase C 306, and phase D 308. Each phase can represent a portion of the online game in which users experience a unique set of features and/or events. For example, when one or more users first join the online game, the users can be placed in phase A 302. As the users progress in the game (e.g., by advancing to higher levels or accomplishing certain tasks), the users can be moved into phase B 304, followed by phase C 306, and then phase D 308. Additional phases can be added, if desired. In some instances, advancement from one phase to another phase can require certain transition criteria to be satisfied. The transition criteria may require, for example, a user or group of users to reach a certain level (e.g., level 10) before advancing from phase A 302 to phase B 304.

As depicted, each phase in the lifecycle 300 can include or be managed by one or more timelines. For example, phase A 302 can include a timeline 310, phase B 304 can include a timeline 312, phase C 306 can include a first timeline 314 and a second timeline 316, and phase D 308 can include a timeline 318. Each of these timelines can be used to determine when items of content are introduced into the online game, as described herein. For phase C 306, the first timeline 314 and the second timeline 316 can be executed in series (e.g., one before the other) or in parallel. In the parallel configuration, the two timelines can overlap and be used to introduce content into the online game at substantially the same time or during overlapping time periods.

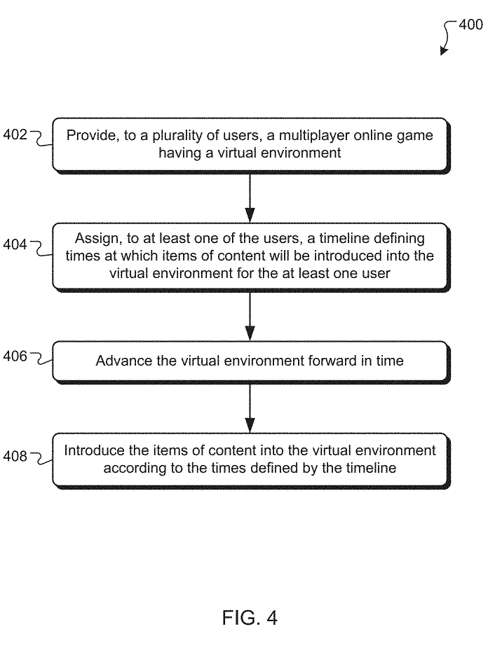

FIG. 4 illustrates an example computer-implemented method 400 of managing the presentation of content in an online game. A multiplayer online game having a virtual environment is provided (step 402) to a plurality of users. A timeline is assigned (step 404) to at least one of the users. The timeline defines times at which items of content will be introduced into the virtual environment for the at least one user. The virtual environment is advanced (step 406) forward in time. The items of content are introduced (step 408) into the virtual environment according to the times defined by the timeline.

In general, the online game and/or a virtual environment for the game can be advanced forward in time in a same or similar manner as time advances in the real world. One or more game clocks for the game can keep track of time within the game and/or the virtual environment. In certain implementations, the game can advance in time regardless of whether users are logged in or playing the game.

In various examples, the use and management of timelines described herein can be directed to building content in games according to a particular timeline in which a user resides. A timeline can represent some or all of the in-game events (significant and/or insignificant) that exist for a given time span for a portion (e.g., a game phase) or all of the game. Each timeline can be established and maintained with regard to certain metrics. The metrics can be measurable statistics of users that can be used to categorize the users and/or to build timelines. For purposes of illustration and not limitation, in the context of timelines the metrics can include, for example, an amount of time a user has been in a game, an amount of time a user has been in a game since first login, an amount of time a user has been in a game since previous login, and other like metrics.

As time progresses for the user in the game (e.g., from a given start time), the user can be delivered pieces of content in an automated way, based on the timeline. Advantageously, the systems and methods described herein make content easier to manage and easier to deliver to users for several reasons. For example, content does not need to be delivered immediately or all at once to an entire game population. The content can instead be rolled out to specific groups of users over time, according to one or more timelines and/or game phases. Additionally or alternatively, the number of game operators required to deliver game content can be reduced significantly. The timeline module 118, for example, can manage millions of users of the game simultaneously and can avoid having to rely on significant manual intervention. Additionally or alternatively, the approach described herein can level the playing field by ensuring that all users receive content, including any associated advantages and disadvantages, in a fair and consistent way. The approach can prevent any users from having a competitive advantage over other users, for example, due to beneficial or harmful content being delivered to users at different times.

Further, instead of having to schedule and maintain a massive list of content for the entire game, the use of multiple timelines and/or game phases described herein can allow game operators to schedule and maintain a smaller, more manageable list of content for each timeline. Additionally or alternatively, instead of maintaining a current state of the entire game, the game operators can maintain a current state (or states) within a timeline. When additional users are added to the game, the operators can choose where in a timeline the users should be placed. In preferred examples, once a new user is placed, the user can automatically experience or re-run states that the timeline describes or otherwise contains.

Consequently, an entire lifecycle of a game can be divided or otherwise broken down into a series of timelines, with each timeline being a subset of the game lifecycle. Each timeline can be of varying length and/or can be contiguous to or partially overlapping with other timelines. Each timeline can include one or more states and associated content depending on, for example, the time length of the timeline, the temporal position of the timeline with respect to the game lifecycle, and other like factors. At any given time, for example, different groups of players can be in different states or parts of the timeline, such as different timeline modules, schedules, or events.

In various examples, the timelines described herein can be managed and built in different levels of abstraction, from smaller building blocks to higher sub-timeline objects. An abstraction can be a grouping within a game, with an entire timeline representing a highest level of abstraction, and portions or modules of a timeline (e.g., schedules or events) representing smaller groupings. Sub-timeline objects, which can be portions or modules of a timeline, can include such smaller groupings. In preferred implementations, some or all of a timeline can be integrated inside another timeline (e.g., by copying or moving timeline modules from one timeline to another timeline). This can greatly facilitate the process of moving or swapping portions or modules between two or more timelines. In particular, the tree structure for timelines described herein can allow for flexibility and simplicity in swapping and re-arranging groups of items (e.g., by allowing the addition of different abstraction levels later). Different levels in the tree structure can be viewed as different abstractions by the game operators. In general, the tree structure makes it easy to extend timelines into the future (e.g., by adding new timeline modules). The structure can have different levels of abstractions, depending on how game operators wants to view the timeline. The structure can make it easier for game operators to think of each sub-tree (e.g., schedule, event, or timeline module) in relation to a parent (e.g., a preceding node), rather than some absolute state that needs maintaining.

While the tree structure is a preferred structure for the timelines described herein, other timeline structures can be utilized. For example, a timeline and/or a game lifecycle can be implemented using a directed acyclic graph (DAG) approach. The DAG approach can allow one or more nodes in a timeline to have multiple parent nodes within the timeline and/or to be accessed from other timelines. Advantageously, this can make the nodes repeatable and/or have one source of truth. For example, when a portion of a timeline (e.g., a module, schedule, or event) is updated, all nodes or timelines pointing to that portion can be updated automatically using the DAG approach.

In various instances, to determine when items of content will be introduced into the online game, the timeline module 118 can flatten the items of content in a timeline and sort the items by time. Various algorithms can be used to achieve this. For example, a PreOrder Traversal or other like algorithm can be used to calculate an exact runtime of each content node in the timeline. Additionally or alternatively, a sorting algorithm or the like (e.g., an Insertion Sort) can be used.

Below is an example application in PHP that can describe a class for creating or otherwise instantiating a timeline. Three visual abstractions can be declared in this example: “Timeline” refers to a root node; “Schedule” refers to a middle-level abstraction for a sub-timeline; and “Event” refers to a lower-level abstraction for a sub-timeline, as described herein.

| | |
|---|---|
| class TimelineNode extends Model | |
| { | |
| const kMaxTypeLength = 100; | |
| const kMaxNameLength = 100; | |
| const kMaxDescLength = 1000; | |
| const kEvent = ‘Event’; | |
| const kSchedule = ‘Schedule’; | |
| const kTimeline = ‘Timeline’; | |
| public static $displayTypes = [ | |
| 1 => self::kEvent, | |
| 2 => self::kSchedule, | |
| 3 => self::kTimeline | |
| ]; | |
| public $node_id | = [Type::uint, PRIMARYAUTOFAST]; |
| public $display_type | = [Type::ascii => self::kMaxTypeLength, |
| INDEXKEY]; public $name | = [Type::ascii => self::kMaxNameLength, |
| INDEXKEY]; public $description | = [Type::ascii => self::kMaxDescLength]; |
| public $create_admin_id | = [Type::uint32]; |
| public $create_ts | = [Type::uint32]; |
| public $modified_admin_id | = [Type::uint32]; |
| public $modified_ts | = [Type::uint32]; |
| ... | |
| } | |
| class TreeNodeChild extends Model | |
| { | |

```
      // Table of allowed classes for a node to contain.
      public static $itemTypes = [
            1 => self::kTreeNodeType,
            2 => ‘BlogPost’
      ];
      const kStart = ‘Start’;
      const kEnd = ‘End’;
      // Table of allowed actions for a node to have.
      public static $itemActions = [
            1 => self::kStart,
            2 => self::kEnd
      ];
```

| | |
|---|---|
| public $node_id | = [Type::uint64, PRIMARYKEY]; |
| public $type_id | = [Type::uint32, PRIMARYKEY]; |
| public $child_id | = [Type::uint64, PRIMARYKEY]; |
| public $action_id | = [Type::uint8, PRIMARYKEY]; |
| public $timestamp | = [Type::int64]; |
| ... | |
| } | |

In some implementations, artificial intelligence and/or one or more trained models or classifiers can be used to build and/or choose timelines for users. For example, data regarding the performance of timelines or components (e.g., modules) thereof can be collected. The performance data can provide an indication of how well a timeline or a component thereof performed in the online game. The performance data can include certain performance indicators such as, for example, computational efficiency, network efficiency, time to completion, user satisfaction, user downtime, and/or revenue. Other performance indicators can be used. The performance data and information for the associated timelines and timeline components can be collected and used to develop a predictive model. For example, the performance data and timeline information can be used as training data to train one or more classifiers. Once trained, the classifier or other predictive model (e.g., a regression equation) can be used to predict the performance of a timeline and/or components thereof. Ultimately, the predictive model can provide recommendations (e.g., based on predicted performance) for which timelines and/or timeline components to utilize in the online game. Such predictions and timeline selections can improve the performance of the computer system used to implement the online game, including, for example, the server system 112, the network 126, and/or any client devices. Such improvements can lead to greater user satisfaction and/or engagement with the online game.

The predictive model can be or include a classifier such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other classifiers can be used.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
providing a multiplayer online game to a plurality of users, the online game comprising a virtual environment;
assigning a timeline to at least one of the users, the timeline defining times at which items of content will be introduced into the virtual environment for the at least one user;
advancing the virtual environment forward in time; and
introducing the items of content into the virtual environment according to the times defined by the timeline.

2. The method of claim 1, wherein the multiplayer online game comprises a lifecycle comprising a plurality of phases.

3. The method of claim 2, wherein the timeline corresponds to a single phase from the plurality of phases.

4. The method of claim 2, wherein each phase comprises at least one distinct timeline.

5. The method of claim 2, wherein at least one phase comprises overlapping timelines.

6. The method of claim 2, wherein the lifecycle comprises a series of timelines, and wherein each timeline in the series comprises a portion of the lifecycle.

7. The method of claim 1, wherein the at least one user comprises a group of new players of the online game.

8. The method of claim 1, wherein the timeline comprises a tree structure comprising nodes and branches.

9. The method of claim 1, wherein the items of content comprise at least one of a game event, a game feature, a game rule, a virtual item, a virtual character, and any combination thereof.

10. The method of claim 1, wherein advancing the virtual environment forward in time comprises running a game clock for the online game.

11. A system, comprising:
one or more computer processors programmed to perform operations comprising:
providing a multiplayer online game to a plurality of users, the online game comprising a virtual environment;
assigning a timeline to at least one of the users, the timeline defining times at which items of content will be introduced into the virtual environment for the at least one user;
advancing the virtual environment forward in time; and
introducing the items of content into the virtual environment according to the times defined by the timeline.

12. The system of claim 11, wherein the multiplayer online game comprises a lifecycle comprising a plurality of phases.

13. The system of claim 12, wherein the timeline corresponds to a single phase from the plurality of phases.

14. The system of claim 12, wherein each phase comprises at least one distinct timeline.

15. The system of claim 12, wherein at least one phase comprises overlapping timelines.

16. The system of claim 12, wherein the lifecycle comprises a series of timelines, and wherein each timeline in the series comprises a portion of the lifecycle.

17. The system of claim 11, wherein the at least one user comprises a group of new players of the online game.

18. The system of claim 11, wherein the timeline comprises a tree structure comprising nodes and branches.

19. The system of claim 11, wherein advancing the virtual environment forward in time comprises running a game clock for the online game.

20. An article, comprising:
a non-transitory computer-readable medium having instructions stored thereon that, when executed by one or more computer processors, cause the computer processors to perform operations comprising:
providing a multiplayer online game to a plurality of users, the online game comprising a virtual environment;
assigning a timeline to at least one of the users, the timeline defining times at which items of content will be introduced into the virtual environment for the at least one user;
advancing the virtual environment forward in time; and
introducing the items of content into the virtual environment according to the times defined by the timeline.
